(19) United States
(12) Patent Application Publication
(10) Pub. No.: US 2020/0303837 A1
(43) Pub. Date: Sep. 24, 2020

(54) PRE-PHASED ANTENNA ARRAYS, SYSTEMS AND METHODS

(71) Applicant: Taoglas Group Holdings Limited, San Diego, CA (US)

(72) Inventor: Christopher M. Anderson, Minneapolis, MN (US)

(21) Appl. No.: 16/773,481

(22) Filed: Jan. 27, 2020

Related U.S. Application Data
(63) Continuation of application No. PCT/IB2018/000871, filed on Jul. 16, 2018.
(60) Provisional application No. 62/537,592, filed on Jul. 27, 2017.

(51) Int. Cl. H01Q 21/28; H01Q 3/24; H01Q 9/04; H01Q 21/22

(52) U.S. Cl. CPC H01Q 21/28; H01Q 21/22; H01Q 9/0407; H01Q 3/247

(57) ABSTRACT

Disclosed are devices, systems and methods relating to a pre-phased antenna array. The disclosed antenna array consists of at least three individual elements, one or more of which are phased-shifted by pre-determined amounts to steer the individual radiation patterns to provide increased spatial communications coverage. By properly combining at least three antennas in an array in fixed positions on a device and switching between them, link budged to a remote radio may be maximized regardless of the orientation of the device.

### CROSS-REFERENCE

This application is a continuation of International Patent Application No. PCT/IB2018/000871, filed Jul. 16, 2018, which claims the benefit of U.S. Provisional Application No. 62/537,592, filed Jul. 27, 2017, entitled PRE-PHASED ANTENNA ARRAYS, SYSTEMS AND METHODS, both of which are incorporated herein by reference.

### BACKGROUND

### Field

The present disclosure relates in general to an antenna and, in particular, to a pre-phased antenna array.

### Background

Next-generation wireless networks will support 1,000-fold gains in capacity, connections for at least 100 billion devices, and a 10 GB/s individual user experience capable of extremely low latency and response times. Deployment of these networks will begin circa 2020. Next-generation radio access will be built upon both new radio access technologies and evolved existing wireless technologies.

Phased array antennas can be composed of at least three radiating elements each with a phase shifter. As will be appreciated by those skilled in the art, a phase shifter can refer to a circuit that can dynamically change a phase delay in response to a control signal. Beams are formed by shifting the phase of the signal emitted from each radiating element, to shift the radiation pattern to the desired direction, thus providing wider coverage than similar non-phase shifted antennas. Phased array antennas are expected to find wide deployment in next-generation radio systems due to a combination of high gain and low power requirements. As such, substantial research and development effort is being directed toward phased array antenna technologies.

What is needed is a next-generation-ready antenna array wherein the phasing of individual antenna elements in the array does not rely on a phase shifter and uses a fixed offset phase network, that is readily integrated into multi-array systems.

### SUMMARY

Disclosed is a next-generation-ready antenna array wherein the phasing of individual antenna elements in the array is pre-determined, that is integratable into multi-array systems. By properly combining at least three antennas in an array in fixed positions on a device and switching between them, link budget to a remote radio may be maximized regardless of the orientation of the device. By using multiple-pre-steered antenna arrays on multiple sides of a radio device, the antenna with the best radio link can be selected at any given time.

An aspect of the disclosure is directed to antenna assemblies. Suitable antenna assemblies comprise: a housing having a surface; at least three antenna elements associated with the housing wherein a radiation pattern for each of the at least three antenna elements emanates from the surface of the housing and further wherein the radiation pattern of one or more of the at least three antenna elements is phase-shifted at least 2 degrees to 88 degrees from a perpendicular plane extending perpendicularly from the surface of the housing. Antenna elements can be selected from patch elements, dipole elements and helical elements. The antenna assembly can have from three to sixty four individual antenna elements. A plurality of antenna elements can be mounted on two or more surfaces of the housing. One or more of the antenna elements can be individually pre-steered so that, for example, two adjacent elements are not steered to provide identical coverage. Additionally, the antenna assembly can be integrated into and comprises one or more components of an antenna system. A communicator can be provided for controlling a selection of one of the antenna elements. The surface can, for example, be a planar surface, a round surface, a concave surface, a convex surface, or a combination thereof.

Another aspect of the disclosure is directed to a system. Suitable systems comprise: an antenna assembly, further comprises a housing having a surface, at least three antenna elements associated with the housing wherein a radiation pattern for each of the at least three antenna elements emanates from the surface of the housing and further wherein the radiation pattern of one or more of the at least three antenna elements is phase-shifted at least 2 degrees to 88 degrees from a perpendicular plane extending perpendicularly from the surface of the housing; and a two-way communications radio device comprising: an internal module to switch between one or more antenna elements in one or more of the at least three antenna elements in response to a signal characteristic. The system can be integrated into an electronic device. Suitable electronic devices include, but are not limited to smart phones, tablets, laptops, etc. One or more of the antenna elements can be pre-steered so that, for example, two adjacent elements are not steered to provide identical coverage. The surface can, for example, be a planar surface, a round surface, a concave surface, a convex surface, or a combination thereof.

Still another aspect of the disclosure is directed to methods of deploying a multi-array antenna system. Suitable methods comprise the steps of: (a) selecting two or more antenna arrays with a three or more antenna elements of known radiation patterns and a respective individual phase shifts; (b) engaging a housing of an electronic device; and (c) connecting each of the two or more antenna arrays to a radio with a switching module which monitors signal parameters and selects among the various antenna arrays for communication. Additionally, the method can include the step of orienting the two or more antenna arrays to provide a target communication coverage. One or more of the antenna elements can be individually pre-steered so that, for example, two adjacent elements are not steered to provide identical coverage.

Still another aspect of the disclosure is directed to a method of deploying an antenna array. Suitable methods comprise the steps of: (a) selecting an antenna array with three or more antenna elements of known radiation patterns and a respective individual phase shifts; and (b) connecting each of the antenna array to a radio with a switching module which monitors signal parameters and selects among the various antenna arrays for communication. Additional steps can include integrating the antenna array into an electronic device. One or more of the antenna elements can be individually pre-steered so that, for example, two adjacent elements are not steered to provide identical coverage.

An aspect of the disclosure is directed to antenna assemblies. Suitable antenna assemblies comprise: a housing means having a surface; at least three antenna element means associated with the housing means wherein a radiation pattern for each of the at least three antenna element means emanates from the surface of the housing means and further wherein the radiation pattern of one or more of the at least three antenna element means is phase-shifted at least 2 degrees to 88 degrees from a perpendicular plane extending perpendicularly from the surface of the housing means. Antenna element means can be selected from patch elements, dipole elements and helical elements. The antenna assembly can have from three to sixty four individual antenna element means. A plurality of antenna element means can be mounted on two or more surfaces of the housing means. One or more of the antenna element means can be individually pre-steered so that, for example, two adjacent elements are not steered to provide identical coverage. Additionally, the antenna assembly can be integrated into and comprises one or more components of an antenna system. A communicator can be provided for controlling a selection of one of the antenna element means. The surface can, for example, be a planar surface, a round surface, a concave surface, a convex surface, or a combination thereof.

Another aspect of the disclosure is directed to a system. Suitable systems comprise: an antenna assembly, further comprises a housing means having a surface, at least three antenna element means associated with the housing means wherein a radiation pattern for each of the at least three antenna element means emanates from the surface of the housing means and further wherein the radiation pattern of one or more of the at least three antenna element means is phase-shifted at least 2 degrees to 88 degrees from a perpendicular plane extending perpendicularly from the surface of the housing means; and a two-way communications radio device comprising: an internal module to switch between one or more antenna element means in one or more of the at least three antenna element means in response to a signal characteristic. The system can be integrated into an electronic device. One or more of the antenna element means can be pre-steered so that, for example, two adjacent elements are not steered to provide identical coverage. The surface can, for example, be a planar surface, a round surface, a concave surface, a convex surface, or a combination thereof.

Still another aspect of the disclosure is directed to methods of deploying a multi-array antenna system. Suitable methods comprise the steps of: (a) selecting two or more antenna arrays with a three or more antenna element means of known radiation patterns and a respective individual phase shifts; (b) engaging a housing means of an electronic device; and (c) connecting each of the two or more antenna arrays to a radio with a switching module which monitors signal parameters and selects among the various antenna arrays for communication. Additionally, the method can include the step of orienting the two or more antenna arrays to provide a target communication coverage. One or more of the antenna element means can be individually pre-steered so that, for example, two adjacent elements are not steered to provide identical coverage.

Still another aspect of the disclosure is directed to a method of deploying an antenna array. Suitable methods comprise the steps of: (a) selecting an antenna array with three or more antenna element means of known radiation patterns and a respective individual phase shifts; and (b) connecting each of the antenna array to a radio with a switching module which monitors signal parameters and selects among the various antenna arrays for communication. Additional steps can include integrating the antenna array into an electronic device. One or more of the antenna element means can be individually pre-steered so that, for example, two adjacent elements are not steered to provide identical coverage.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

4G AMERICAS MIMO and Smart Antennas for Mobile Broadband Systems (October 2012);

BIGLARBEGIAN, Integrated Antennas and Active Beamformers Technology for mm-Wave Phased-Array Systems (2012);

SCHOEBEL et al. Planar Antenna Technology for mm-Wave Automotive Radar, Sensing and Communications, Radar Technology book edited by G. Kouemou (December 2009);

US 2013/0300602 A1 published Nov. 14, 2013 to Zhou et al. for Antenna Arrays with Configurable Polarizations and Devices Including Such Antenna Arrays;

US 2015/034921 A1 published Dec. 3, 2015 to Sharawi for Millimeter (MM) Wave Switched Beam Antenna System;

U.S. Pat. No. 6,067,053 A issued May 23, 2000 to Runyon et al. for Dual Polarized Array Antenna;

U.S. Pat. No. 6,121,931 A issued Sep. 19, 2000 to Levi for Planar Duel-Frequency Array Antenna;

U.S. Pat. No. 7,126,541 B2 issued Oct. 24, 2006 to Mohamadi for Beam Forming Phased Array System in a Transparent Substrate;

U.S. Pat. No. 8,022,887 B1 issued Sep. 20, 2011 to Zarnaghi for Planar Antenna;

U.S. Pat. No. 8,106,849 B2 issued Mar. 31, 2012 to Reavis et al. for Planar Antenna Array and Article of Manufacture Using Same;

U.S. Pat. No. 8,493,281 B2 issued Jul. 23, 2013 to Lam et al. for Lens for Scanning Angle Enhancement of Phased Array Antennas;

U.S. Pat. No. 8,604,989 B1 issued Dec. 10, 2013 to Olson for Steerable Antenna;

U.S. Pat. No. 9,119,061 B2 issued Aug. 25, 2015 to Mohamadi for Integrated Water Scale, High Data Rate, Wireless Repeated Placed on Fixed or Mobile Elevated Platforms;

U.S. Pat. No. 9,214,739 B2 issued Dec. 15, 2015 to Sover et al. for Overlapped and Staggered Antenna Arrays;

U.S. Pat. No. 9,590,315 B2 issued Mar. 7, 2017 to Evtyushkin et al. for Planar Linear Phase Array Antenna with Enhanced Beam Scanning; and

U.S. Pat. No. 9,692,124 B2 issued Jun. 27, 2017 to Caimi et al. for Antenna Structures and Methods Thereof That Have Disparate Operating Frequency Ranges.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is an isometric illustration of the disclosed antenna assembly as viewed from above;

FIG. 2 is an illustration of the radiation pattern and orientation of an antenna element;

FIG. 3 is an illustration of the radiation pattern and orientation of an antenna element;

FIG. 4 is an illustration of the radiation pattern and orientation of an antenna element;

FIG. 5 is an illustration of the radiation pattern and orientation of an antenna element;

FIG. 6 is an illustration of the radiation pattern and orientation of an antenna element;

FIG. 7 is an illustration of the radiation pattern and orientation of an antenna element;

FIGS. 8A-B are a side view of a first configuration of an antenna assembly with radiation patterns extending from a surface and a top view of a second configuration of an antenna assembly with radiation patters extending from a surface; and

FIG. 9 is an illustration of a system of antenna arrays according to the disclosure.

### DETAILED DESCRIPTION OF THE PREFERRED EMBODIMENT

Disclosed are a high-gain antenna array that is physically pre-steered either by the transmission line or by lumped element phasing and a scheme for deploying two or more of the disclosed high-gain arrays in different orientations on user equipment, thus ensuring that at least one of the arrays will point in a useful direction in order to close the radio link to a base station. Combined with one or more radios integrated in the user equipment, such a system enables maximization of signal quality to a remote radio regardless of the orientation of the user equipment in question. The system has a housing which can be the housing of a radio device including, for example a smartphone.

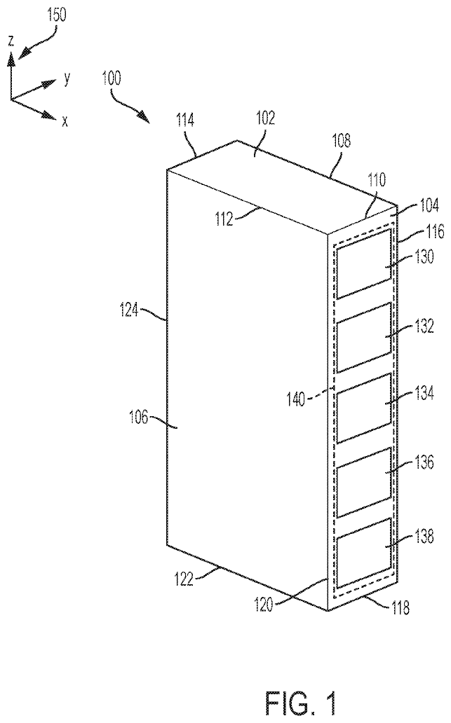

FIG. 1 is an isometric illustration of an antenna assembly 100 according to the disclosure. In the exemplar depiction, the antenna assembly 100 is illustrated as a rectangular solid having six faces. Visible in the isometric illustration of FIG. 1 are the top face 102, front face 104, and first side face 106. Top face 102 is rectangular in shape, with a first edge 108, second edge 110, third edge 112 and a fourth edge 114, proceeding in a clockwise fashion as viewed from the positive z-axis of reference coordinate system 150. First edge 108 lies opposite third edge 112, and second edge 110 lies opposite fourth edge 114. In the example depicted in FIG. 1, first edge 108 and third edge 112 are depicted as approximately 2.5 times the length of second edge 110 and fourth edge 114. As will be appreciated by those skilled in the art, other shapes and sizes of the antenna assembly 100 can be used without departing from the scope of the disclosure.

As will be appreciated by those skilled in the art, there is no restriction in the geometry of the device, although FIG. 1 illustrates a rectangular box. For example, the device could be round like a hockey puck or spherical like a baseball. Some features of the device would enforce that the antennas around the perimeter are aligned in an X-Y plane. A spherical embodiment could have a flat portion on two sides or feet that resulted in it sitting flat on a surface.

As will be appreciated by those skilled in the art, an object lying flat on a surface will need to communicate, in most cases, with another device that is positioned in an X-Y plane that is parallel to the surface of the earth. For this reason, there is no restriction on the actual geometry of the antenna assembly 100.

In the exemplar illustration of FIG. 1, front face 104 is rectangular in shape and shares a common edge, second edge 110, with top face 102. Thus, the edges which bound the front face 104 are second edge 110, fifth edge 116, sixth edge 118, and seventh edge 120, numbered clockwise when viewed from the positive x-axis of reference coordinate system 150. Second edge 110 lies opposite sixth edge 118, and fifth edge 116 lies opposite seventh edge 120. A fifth edge 116 and seventh edge 120 are approximately 5 times the length of second edge 110 and sixth edge 118 as shown in the exemplar configuration.

First side face 106 is rectangular in shape and shares one common edge, third edge 112, with top face 102 and another common edge, seventh edge 120, with front face 104. The edges which bound the first side face 106 are third edge 112, seventh edge 120, eighth edge 122, and ninth edge 124, numbered clockwise when viewed from the negative y-axis of reference coordinate system 150. As illustrated in FIG. 1, third edge 112 lies opposite eighth edge 122, and seventh edge 120 lies opposite ninth edge 124.

Located on front face 104, are five antenna elements of identical physical dimension, arranged equally-spaced from top to bottom. Proceeding from second edge 110 toward sixth edge 118 are first antenna element 130, second antenna element 132, third antenna element 134, fourth antenna element 136, and fifth antenna element 138. In the embodiment depicted in FIG. 1, first antenna element 130, second antenna element 132, third antenna element 134, fourth antenna element 136, and fifth antenna element 138 are rectangular patch elements whose sides align along either the y-axis or the z-axis of reference coordinate system 150. Together, first antenna element 130, second antenna element 132, third antenna element 134, fourth antenna element 136, and fifth antenna element 138 comprise antenna array 140.

As will be appreciated by those skilled in the art, five antennas are depicted, but configurations can be employed which use three or more antenna elements on any side of the device. If the antenna assembly has flat sides, a view from a top surface could result in an array pointing to the left, one pointing straight, and another pointing to the right. For a tubular configuration, the antennas would not require phase steering as each antenna around the circumference of the assembly would naturally point in the correct direction. Orientation of the antennas need not be in a single direction. [0050] The radiation pattern of each antenna element in antenna array 140 is fan-shaped and roughly planar. Each antenna element in antenna array 140 is phase-steered by a specific angular amount so that the combined radiation pattern provides the desired coverage.

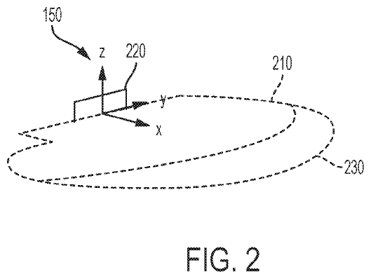

FIG. 2 is an isometric depiction of a generic antenna element 220 similar to those in antenna array 140 shown in FIG. 1. For clarity, reference coordinate system 150 from FIG. 1 has been positioned in FIG. 2 so that its origin corresponds to the geometric center of generic antenna element 220. Generic radiation pattern 210 is fan-shaped and lies largely in the x-y plane; peak gain 230 occurs along the positive x-axis.

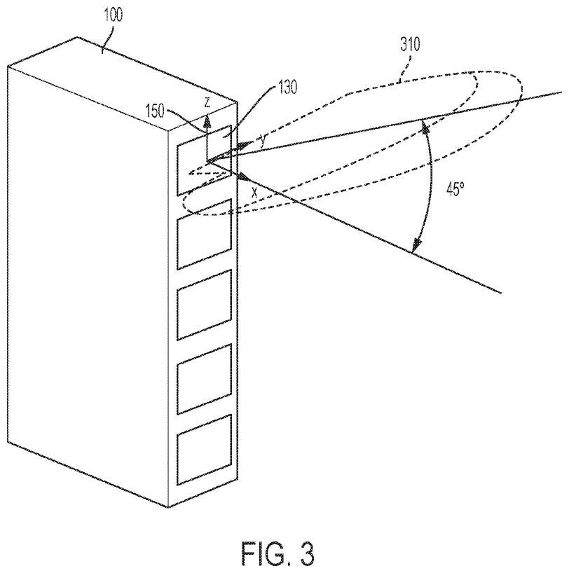

FIG. 3 is an isometric view of the antenna assembly 100 of FIG. 1 that illustrates an exemplar phase-shifted orientation of a radiation pattern of a first antenna element 130. Reference coordinate system 150 is placed with its origin at the geometric center of first antenna element 130. First antenna element radiation pattern 310 extending from the face of the antenna assembly 100 is identical in shape to the generic radiation pattern 210 shown in FIG. 2 and is elevated from the x-y plane by a 45 degree phase shift.

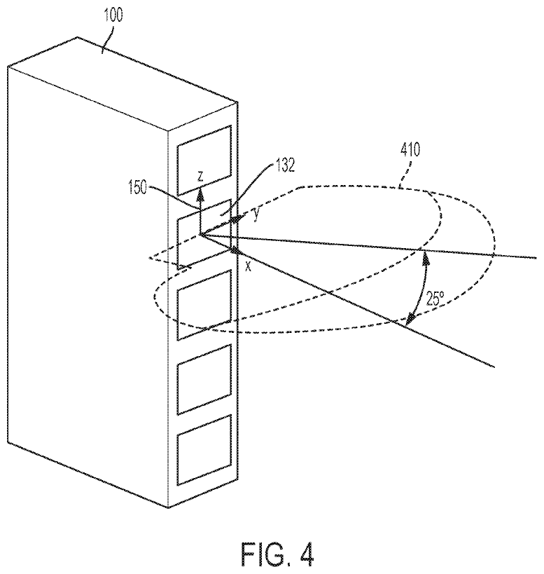

FIG. 4 is an isometric view of the antenna assembly 100 of FIG. 1 that illustrates the phase-shifted orientation of the radiation pattern of second antenna element 132. Reference coordinate system 150 is placed with its origin at the geometric center of second antenna element 132. Second antenna element radiation pattern 410 is identical in shape to generic radiation pattern 210 of FIG. 2 and is elevated from the x-y plane by 25 degrees via phase shifting.

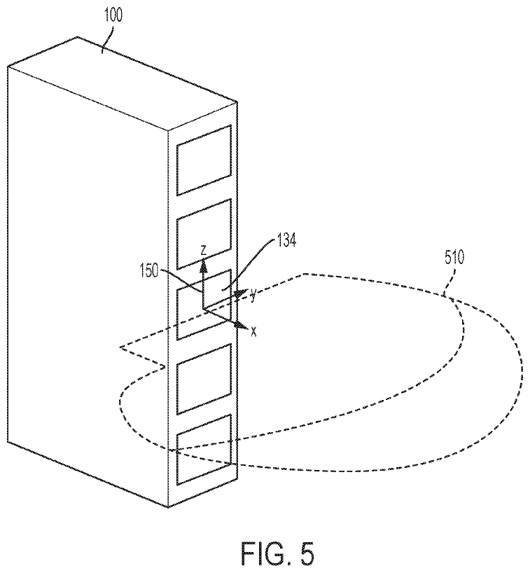

FIG. 5 is an isometric view of the antenna assembly 100 of FIG. 1 that illustrates the orientation of the radiation pattern of third antenna element 134. Reference coordinate system 150 is placed with its origin at the geometric center of third antenna element 134. Third antenna element radiation pattern 510 is not phase-shifted and thus lies in the x-y plane, making it identical in shape and orientation to generic radiation pattern 210 shown in FIG. 2.

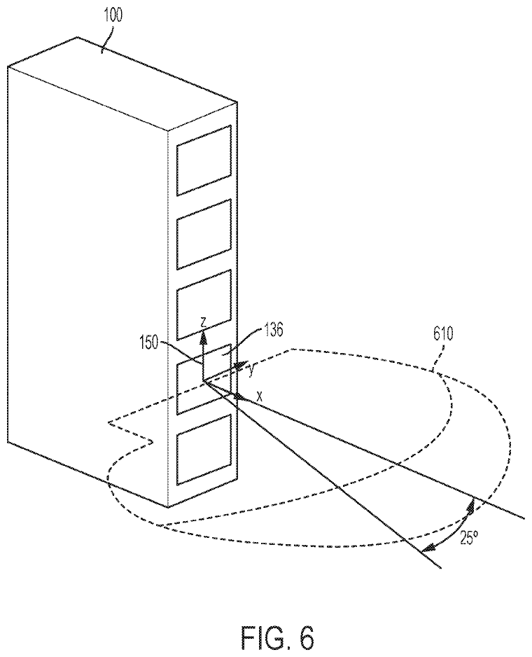

FIG. 6 is an isometric view of the antenna assembly 100 shown in FIG. 1 that illustrates the phase-shifted direction of the radiation pattern of fourth antenna element 136. Reference coordinate system 150 is placed with its origin at the geometric center of fourth antenna element 136. Fourth antenna element radiation pattern 610 is identical in shape to generic radiation pattern 210 of FIG. 2 and is depressed from the x-y plane by 25 degrees via phase shifting.

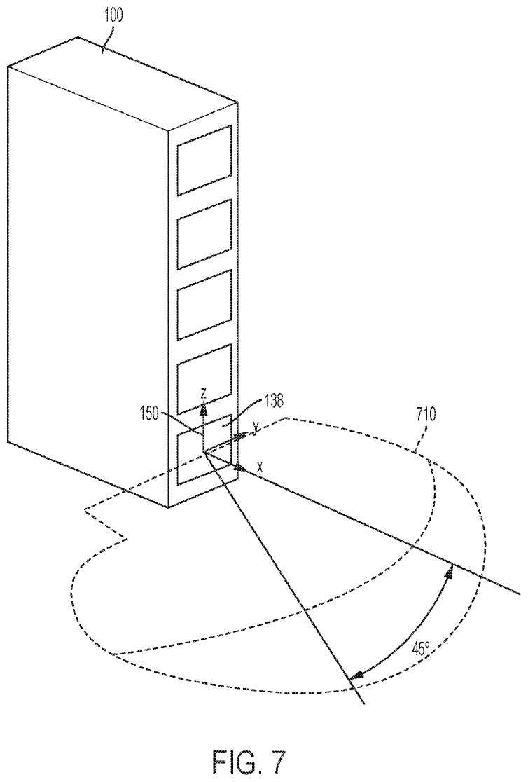

FIG. 7 is an isometric view of the antenna assembly 100 of FIG. 1 that illustrates the phase-shifted direction of the radiation pattern of fifth antenna element 138. Reference coordinate system 150 is placed with its origin at the geometric center of fifth antenna element 138. Fifth antenna element radiation pattern 710 is identical in shape to generic radiation pattern 210 of FIG. 2 and is depressed from the x-y plane by 45 degrees via phase shifting.

Combined, the radiation patterns of first antenna element 130, second antenna element 132, third antenna element 134, fourth antenna element 136, and fifth antenna element 138, which form an antenna array 140, provide broad communications coverage. In alternate embodiments, the number of antenna elements in an array can vary from 3 to 64, as an example. The more antenna elements, the sharper the beam created by each antenna element. The phase shift aspect alters the radiation pattern to steer the beam along the long axis of the array. The beam can be steers+/−60° away from the perpendicular to the plane of the antenna array. Where arrays of smaller number of antenna elements are used there might be a higher peak gain than using a single array but the beam width will still be flat, having a beam width of, for example, +/−25°. One array could have coverage from −50 to 0, another of −25 to +25, and another from 0 to +50 when mounted on the same side of a flat device.

With prior knowledge of individual antenna element radiation pattern(s); by properly pre-selecting phase shift for each antenna element within the antenna array 140 of FIG. 1; and by properly selecting the number and orientation of antenna assemblies 100 of FIG. 1, a multiple-antenna-array system may be constructed that uses a radio with a switching module to monitor signal parameters and select among the various antenna arrays in order to maximize link budget and maintain communications integrity of said system with remote communications device(s).

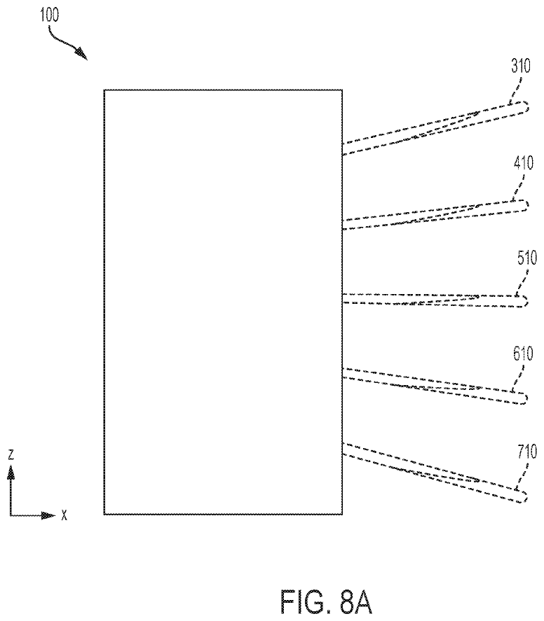

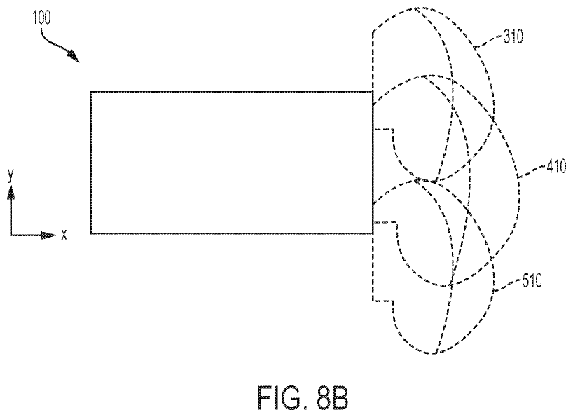

FIG. 8A illustrates an antenna assembly 100 from a side view with a plurality of radiation patterns extending from the face of the assembly where the antenna elements are positioned one on top of another vertically. As will be appreciated by those skilled in the art, the antenna assembly 100 is configurable so that the radiation patterns vary in the x-axis (as shown). Alternatively, as shown in FIG. 8B the radiation patterns can vary in the y-axis so that, when a three antenna configuration is viewed from above, one radiation pattern would extend from the assembly and point to the left, one radiation pattern would extend from the assembly and point to the center, and one radiation pattern would extend from the assembly and point to the right. Where the assembly is curved, positioning the antennas adjacent each other on a curved surface would also result in a phasing of the antenna.

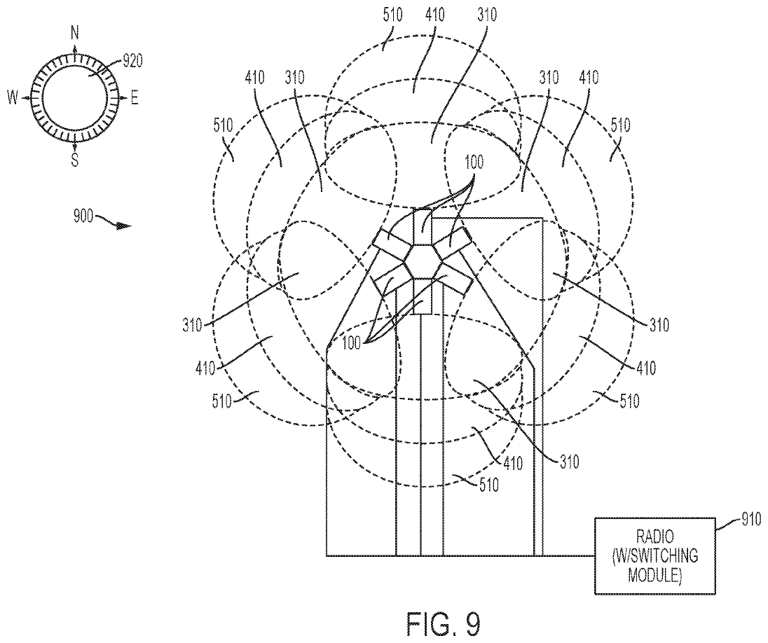

FIG. 9 illustrates an example of a multi-array antenna system 900, viewed from above, comprising six antenna assemblies 100 of FIG. 1 according to the disclosure, as they might be arranged, for example, within a user equipment device. The plurality of antenna assemblies 100 of FIG. 1 are arranged at regular 60 degree intervals in the multi-array antenna system 900 shown in FIG. 9, each with front face 104 of the antenna assembly 100 of FIG. 1 oriented in the multi-array antenna system 900 of FIG. 9 so that the front face 104 faces outward. As illustrated, the ends of the fourth edge 114 of each of the antenna assembly 100 of FIG. 1 shown in the multi-array antenna system 800 of FIG. 9 coincide with the fourth edge 114 of its immediately neighboring antenna assembly 100, defining a regular hexagon space between the fourth edge of each of the antenna assemblies when viewed from above as shown in FIG. 9.

Also visible in FIG. 9 are first antenna element radiation pattern 310 of FIG. 3, the second antenna element radiation pattern 410 of FIG. 4, and third antenna element radiation pattern 510 of FIG. 5 radiating from each of the antenna assemblies comprising the multi-array antenna system. Referring to compass rose 920, it is evident that such an embodiment provides 360 degree azimuth angle communications coverage. Combined with broad elevation range of each of the antenna assemblies 100, the multi-array antenna system 900 could maintain communications with a remote radio, such as a base transceiver station, regardless of orientation of the device within which it is housed. Each antenna assembly 100 is connected to radio 910, which contains a switching module. The switching module evaluates signal characteristics, such as strength, quality, and/or integrity of the signals from each antenna assembly 100 and switches communications of radio 910 to one or more antenna assemblies 100, depending on signal characteristics. Any array can be switched in to connect to a radio to provide the best available radio link. As will be appreciated by those skilled in the art, only one antenna array can be connected to one radio.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. An antenna assembly comprising:
a housing having a surface;
at least three antenna elements associated with the housing wherein a radiation pattern for each of the at least three antenna elements emanates from the surface of the housing and further wherein the radiation pattern of one or more of the at least three antenna elements is phase-shifted from at least 2 degrees to at least 88 degrees from a perpendicular plane extending perpendicularly from the surface of the housing.

2. The antenna assembly of claim 1 wherein the antenna elements are selected from patch elements, dipole elements and helical elements.

3. The antenna assembly of claim 1 further comprising from three to sixty four individual antenna elements.

4. The antenna assembly of claim 1 wherein a plurality of antenna elements are mounted on two or more surfaces of the housing.

5. The antenna assembly of claim 1 wherein the antenna elements are pre-steered.

6. The antenna assembly of claim 1 wherein the antenna assembly is integrated into and comprises one or more components of an antenna system.

7. The antenna assembly of claim 1 further comprising a communicator for controlling a selection of one of the antenna elements.

8. The antenna assembly of claim 1 wherein the surface is a planar surface.

9. A system comprising:
an antenna assembly, further comprises a housing having a surface, at least three antenna elements associated with the housing wherein a radiation pattern for each of the at least three antenna elements emanates from the surface of the housing and further wherein the radiation pattern of one or more of the at least three antenna elements is phase-shifted at least 2 degrees to 88 degrees from a perpendicular plane extending perpendicularly from the surface of the housing; and
a two-way communications radio device comprising: an internal module to switch between one or more antenna elements in one or more of the at least three antenna elements in response to a signal characteristic.

10. The system of claim 9 wherein the system is integrated into an electronic device.

11. The system of claim 9 wherein the antenna elements are pre-steered.

12. The system of claim 9 wherein the surface is a planar surface.

13. A method of deploying a multi-array antenna system comprising the steps of:
(a) selecting two or more antenna arrays with a three or more antenna elements of known radiation patterns and a respective individual phase shifts;
(b) engaging a housing of an electronic device; and
(c) connecting each of the two or more antenna arrays to a radio with a switching module which monitors signal parameters and selects among the various antenna arrays for communication.

14. The method of claim 13 further comprising the step of:
orienting the two or more antenna arrays to provide a target communication coverage.

15. The method of claim 13 wherein the antenna elements are pre-steered.
